(19) United States
(12) Patent Application Publication
(10) Pub. No.: US 2014/0191606 A1
(43) Pub. Date: Jul. 10, 2014

(54) MULTI-CHANNEL WOUND-FIELD SYNCHRONOUS MACHINE

(71) Applicant: HAMILTON SUNDSTRAND CORPORATION, Windsor Locks, CT (US)

(72) Inventors: Jacek F. Gieras, Glastonbury, CT (US); Gregory I. Rozman, Rockford, CT (US)

(73) Assignee: HAMILTON SUNDSTRAND CORPORATION, Windsor Locks, CT (US)

(21) Appl. No.: 13/738,481

(22) Filed: Jan. 10, 2013

(51) Int. Cl. H02K 16/00; H02K 15/06

(52) U.S. Cl. CPC H02K 16/00; H02K 15/06
USPC 310/112; 29/596

(57) ABSTRACT

A multi-channel wound-field synchronous machine and method of assembling a multi-channel axial-flux wound-field synchronous machine are described. The machine includes an even number of stators and a plurality of field-excitation windings, each of the plurality of field-excitation windings being associated with a respective one of the stators. The machine also includes an exciter to feed all of the plurality of field-excitation windings.

### BACKGROUND OF THE INVENTION

Exemplary embodiments pertain to the art of supplying power.

In various applications, the reliability of a power supply can have implications that go beyond inconvenience. For example, the power supply of an important aircraft instrument, actuator, or pump may benefit from redundancy to alleviate safety concerns. While redundancy is beneficial to the reliability of important systems, the consideration of reliability must be balanced with the consideration of other factors, such as weight and size, for example.

### BRIEF DESCRIPTION OF THE INVENTION

Disclosed is an embodiment of a multi-channel axial-flux wound-field synchronous machine including an even number of stators; a plurality of field-excitation windings, each of the plurality of field-excitation windings being associated with a respective one of the stators; and an exciter configured to feed all of the plurality of field-excitation windings.

Also disclosed is an embodiment of a method of assembling a multi-channel wound-field synchronous machine including disposing an even number of poly-phase stators in a housing; disposing a plurality of field-excitation windings in the housing and associating each of the plurality of rotor field-excitation windings with a respective one of the poly-phase stators; and disposing an exciter in the housing, the exciter being coupled to the plurality of rotor field-excitation windings.

### BRIEF DESCRIPTION OF THE DRAWINGS

The following descriptions should not be considered limiting in any way. With reference to the accompanying drawings, like elements are numbered alike:

FIG. 1 is a side view of a two-channel wound field synchronous machine according to an embodiment of the invention;

FIG. 2 is a side view of a four-channel wound field synchronous machine according to an embodiment of the invention; and

FIG. 3 is a flow diagram of a method of assembling a multi-channel wound-field synchronous machine according to an embodiment of the invention.

### DETAILED DESCRIPTION OF THE INVENTION

A detailed description of one or more embodiments of the disclosed apparatus and method are presented herein by way of exemplification and not limitation with reference to the Figures.

As noted above, a redundant power supply designed in consideration of size and weight can be essential in applications such as airborne or land vehicle applications, for example. Embodiments of the invention detailed herein describe a multi-channel power supply implemented in an axial-flux wound-field synchronous machine architecture. The machine according to the various embodiments provides torque density and power density that is sufficiently high to facilitate redundancy in the power supply while also providing a lighter solution than a radial flux machine.

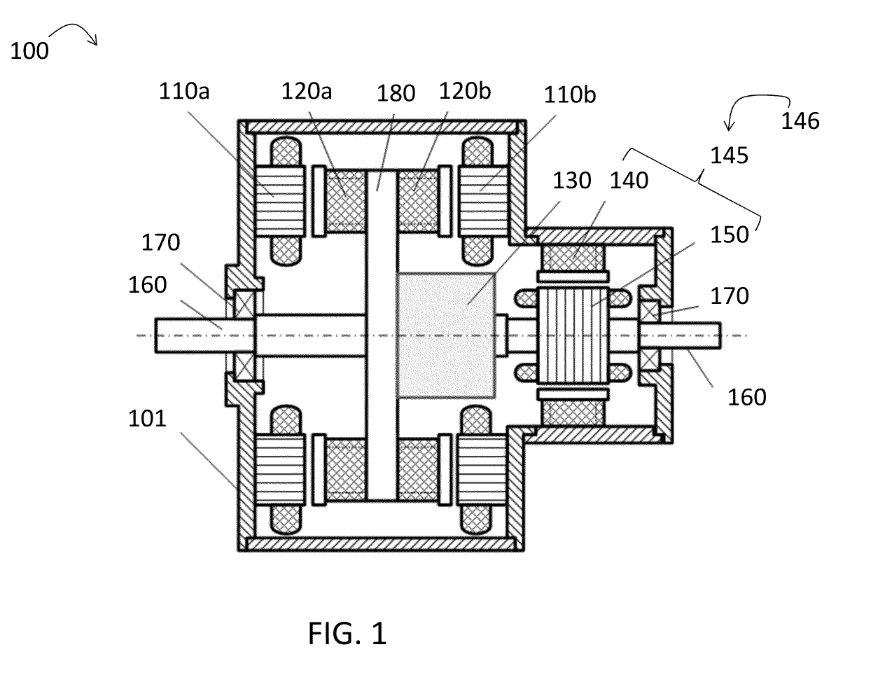

FIG. 1 shows a two-channel wound field synchronous machine 100 according to an embodiment of the invention. In a wound field machine, the rotor field-excitation windings 120 rather than a permanent magnet generate the magnetic field in the machine (generator) with the stators 110 acting as poly-phase armature systems. The machine 100 housing 101 includes two stators 110, two field-excitation windings 120, rotating power electronics unit 130, field excitation winding 140 of brushless exciter 145, and a single-phase or poly-phase armature system 150 of the brushless exciter 145. In the illustrated embodiment, the field-excitation winding 120a is associated with stator 110a, and the field-excitation winding 120b is associated with stator 110b. Both field-excitation windings 120a and 120b are fed from the same exciter 146. Although excitation current is provided by one exciter 146 (e.g., brushless exciter 145 associated with field excitation winding 140 and armature system 150), each stator 110a and 110b is excited independently and operates on an independent load. In addition, there is a separate electronic system (within the power electronics unit 130) for each of the field-excitation windings 120a and 120b associated with each stator 110a and 110b. The power electronics unit 130 unit may include diodes, solid-state switches, or a combination of diodes and solid-state switches. Electrical connections between the armature system 150 of the brushless exciter 145, power electronics unit 130, and field-excitation windings 120 of the main machine are made through a hollow shaft 160 held by bearings 170 using electrical connecting wires (not shown).

The main generator of the machine 100 includes the two stators 110, two field-excitation windings 120, and the rotor 180, and the exciter portion of the machine 100 includes the field-excitation winding 140 and armature system 150 of the brushless exciter 145. Power is supplied to the power electronics 130, which in turn imputes power to each rotor 180. The two-channel machine 100 according to the embodiment shown in FIG. 1 may provide a redundant power supply (single channel) when the two stators 110 are connected in parallel.

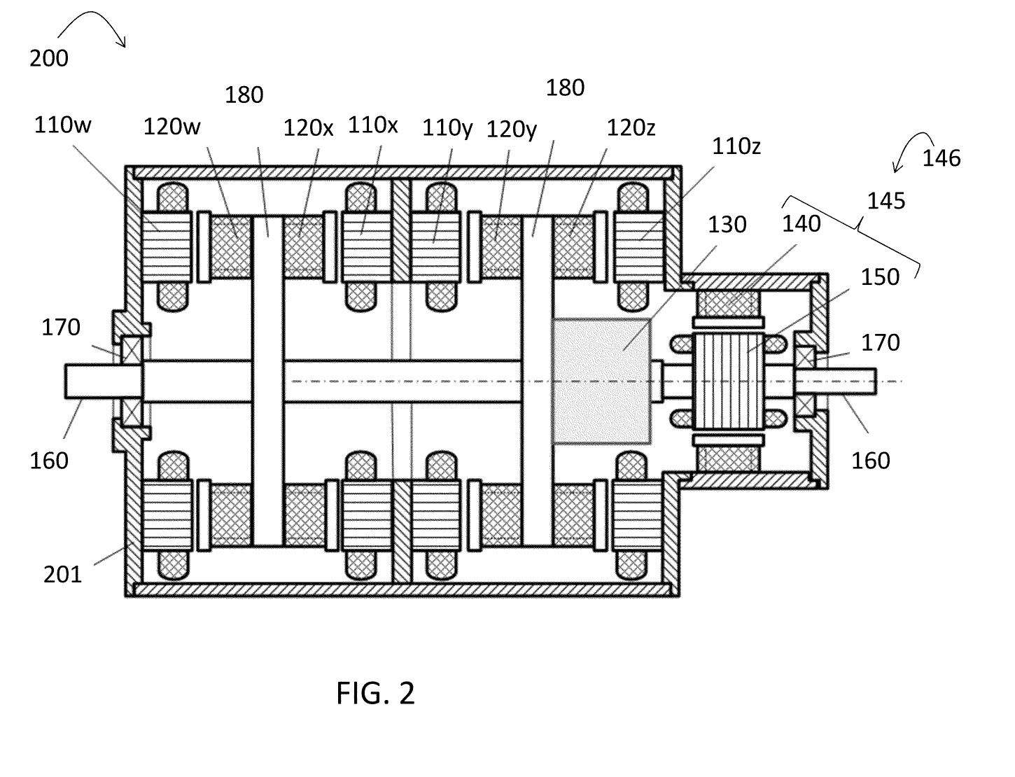

FIG. 2 is a block diagram of a four-channel wound field synchronous machine 200 according to an embodiment of the invention. The machine 200 housing 201 includes four stators 110. In the embodiment shown in FIG. 2, the field-excitation winding 120w is associated with stator 110w, the field-excitation winding 120x is associated with stator 110x, the field-excitation winding 120y is associated with stator 110y, and the field-excitation winding 120z is associated with stator 110z. All of the field-excitation windings 120 are fed from the same exciter 146 (e.g., brushless exciter 145 associated with field excitation winding 140 and armature system 150). The machine 200 may be used as a one, two, or four-channel power supply. All four stators (110w-110z) may be connected in parallel to provide a redundant one-channel power output. The stators 110w and 110x may be connected in parallel as one channel and the stators 110y and 110z may be connected in parallel as another channel to provide a redundant two-channel power output. Each stator 110 may be used without redundancy to provide a four-channel power output.

Based on the architecture illustrated by the embodiments shown in FIG. 1 and FIG. 2, any even number of independent stators 110 and associated field-excitation windings 120 from the same exciter 146 (e.g., 145) may be generated in a similar way. Accordingly, any even number of channels (e.g., 2, 4, 6) may be used to provide a power supply with one or more redundant power outputs (e.g., 1, 2, 3). For example, an aircraft fuel pump typically has two motors. With the architecture illustrated by the embodiments shown in FIGS. 1 and 2, a number of combinations of power supplies is possible. In one embodiment, the machine 100 may be used and each stator 110 may supply power to each fuel pump motor (i.e. 110a to one motor and 110b to the other motor). In one alternate embodiment, the machine 200 may be used and stators 110w and 110x may be connected in parallel to the first fuel pump motor while stators 110y and 110z may be connected in parallel to the second fuel pump motor. In this embodiment, each of the fuel pump motors would have a redundant power supply. In yet another embodiment, two machines 100 may be used and each machine 100 may have the stators 110a and 110b connected in parallel to supply redundant power to each respective fuel pump motor.

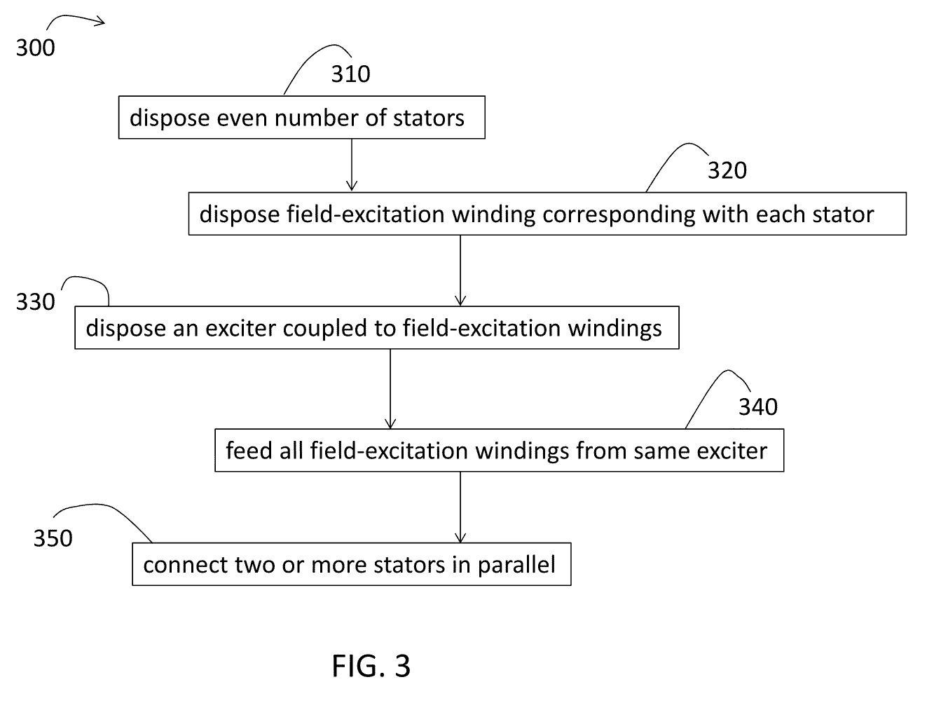

FIG. 3 is a flow diagram of a method 300 of assembling a multi-channel wound-field synchronous machine according to an embodiment of the invention. Disposing an even number of stators 110 (block 310) includes, for example, disposing two stators (110a and 110b) as in the embodiment shown in FIG. 1, disposing four stators (110w-110z) as in the embodiment shown in FIG. 2, or disposing 6, 8, or more stators 110. At block 320, the method 300 includes disposing a field-excitation winding 120 corresponding with each stator 110. For example, in the embodiment shown at FIG. 1, field-excitation windings 120a and 12b correspond with stators 110a and 110b, respectively. Disposing an exciter 146 (e.g., 145) coupled to the field-excitation windings 120 (block 330) facilitates feeding all the field-excitation windings 120 from the same exciter 146 (block 340). The multi-channel wound-field synchronous machine assembled according to the method 300 provides redundancy in power supply by connecting two or more stators in parallel (block 350).

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A multi-channel axial-flux wound-field synchronous machine, comprising:
an even number of stators;
a plurality of field-excitation windings, each of the plurality of field-excitation windings being associated with a respective one of the stators; and
an exciter that feeds all of the plurality of field-excitation windings.

2. The machine according to claim 1, wherein the exciter is a brushless exciter comprising a field excitation winding and a single-phase or poly-phase armature system.

3. The machine according to claim 2, further comprising a hollow shaft configured to carry electrical connections between the single-phase or poly-phase armature system of the brushless exciter, rotating power electronics, and the plurality of field-excitation windings.

4. The machine according to claim 1, further comprising a housing configured to enclose the stators and the plurality of field-excitation windings.

5. The machine according to claim 1, further comprising one or more rotors, each of the one or more rotors associated with a respective pair of the stators.

6. The machine according to claim 1, wherein two or more of the stators may be connected in parallel to provide a redundant power supply.

7. A method of assembling a multi-channel axial-flux wound-field synchronous machine, the method comprising:
disposing an even number of poly-phase stators in a housing;
disposing a plurality of rotor field-excitation windings in the housing and associating each of the plurality of rotor field-excitation windings with a respective one of the stators; and
disposing an exciter in the housing, the exciter being coupled to the plurality of rotor field-excitation windings.

8. The method according to claim 7, wherein disposing the exciter includes disposing a brushless exciter comprising a rotor field excitation winding and a single-phase or poly-phase armature system.

9. The method according to claim 8, further comprising disposing a hollow shaft across the housing, the shaft carrying electrical connections between the single-phase or poly-phase armature system of the brushless exciter, rotating power electronics, and the plurality of rotor field-excitation windings.

10. The method according to claim 7, further comprising disposing one or more rotors in the housing, each of the one or more rotors being associated with a respective pair of the poly-phase stators.

11. The method according to claim 7, further comprising connecting two or more of the poly-phase stators in parallel to provide a redundant power supply.

12. The method according to claim 7, further comprising providing each of the poly-phase stators as an individual power supply.
